(19) United States
(12) Patent Application Publication
(10) Pub. No.: US 2024/0283526 A1
(43) Pub. Date: Aug. 22, 2024

(54) FIELD DISASTER MONITORING SYSTEM AND METHOD BASED ON AIRCRAFT RELAY COMMUNICATION

(71) Applicants: Weijun PAN, Guanghan City (CN); CIVIL AVIATION FLIGHT UNIVERSITY OF CHINA, Guanghan City (CN)

(72) Inventors: Weijun PAN, Guanghan City (CN); Zonghuan WU, Guanghan City (CN); Xinping ZHU, Guanghan City (CN); Yuanfei LENG, Guanghan City (CN); Xuan WANG, Guanghan City (CN); Rundong WANG, Guanghan City (CN); Qinghai ZUO, Guanghan City (CN); Tian LUAN, Guanghan City (CN); Yuanjing HUANG, Guanghan City (CN)

(21) Appl. No.: 18/650,429

(22) Filed: Apr. 30, 2024

Related U.S. Application Data
(63) Continuation of application No. PCT/CN2022/139607, filed on Dec. 16, 2022.

(30) Foreign Application Priority Data
Jun. 28, 2022 (CN) 202210778040.3

(51) Int. Cl. H04B 7/185; H04Q 9/00

(52) U.S. Cl. CPC H04B 7/18504; H04Q 9/00; H04Q 2209/80

(57) ABSTRACT

The application belongs to the technical field of public safety, in particular to a field disaster monitoring system and method based on an aircraft relay communication, including a sensing communication terminal, an aircraft relay station and a data center server; the sensing communication terminal is used for collecting information in the field area in real time, and is connected with an airborne aircraft relay station through wireless signals transmitting the collected information; the aircraft relay station is in communication connection with a data center server through a wireless network for sending the information to the data center server; the data center server is used for receiving and analyzing the information.

### CROSS-REFERENCE TO RELATED APPLICATIONS

This application is a continuation of PCT/CN2022/139607, filed on Dec. 16, 2022 and claims priority of Chinese Patent Application No. 202210778040.3, filed on Jun. 28, 2022, the entire contents of which are incorporated herein by reference.

### TECHNICAL FIELD

The application belongs to the technical field of public safety, and in particular to a field disaster monitoring system and a method based on aircraft relay communication.

### BACKGROUND

In the fields of disaster management, emergency rescue, field observation and public safety, due to the sudden events, complex field terrain and being far away from human settlements, there is a lack of conditions for quickly constructing communication and transportation systems.

In the case of forest fire prevention, because of the lush vegetation in the forest, many inflammable and combustible materials such as fallen leaves, and often in remote areas with inconvenient transportation, it is very difficult to rely on personnel to guard. Once a forest fire occurs, it will spread quickly, and when people find it, it will often spread to a large area, and it is difficult to organize a large number of personnel and equipment to put it out in time. Forest fire will cause serious loss of life and property and pollution of the natural environment. At present, people usually use artificial lookout, artificial patrol and satellite detection to alarm forest fires. These methods are interfered by weather and vegetation conditions, so it is difficult to achieve all-weather real-time monitoring. Similar problems also exist in earthquakes, floods, etc. When a natural disaster occurs, it is necessary to get the information of the disaster site in time and make the correct decision as quickly as possible. However, the equipment for information collection is not always available at the disaster site, so it is difficult for rescuers to arrive at the scene in time, making it impossible to obtain the information in time.

In addition to natural disasters, in large-scale human activities such as marathon and 100-kilometer cross-country, in case of sudden danger, due to lack of information, casualties and other major losses often occur.

In many scenes, such as surgical observation, fugitive pursuit, etc., it is often necessary to quickly establish systematic perception and communication facilities for a certain area and build a field monitoring and communication system.

At present, the construction of field observation and communication system still has some defects, such as high cost, long period, low robustness and dependence on manpower. For example, fire monitoring is often carried out in the following ways.

(1) The monitoring personnel observe the fire on the watchtower, and after observing the fire, the monitoring personnel calls the fire fighters. This method has the problems of slow response and low accuracy of monitoring results.

(2) The on-site monitoring video shot by the monitoring camera is networked and transmitted to the control room through the ground relay station, and the real-time observation and monitoring are carried out in the detection room manually. This method has the disadvantages that the monitoring range is limited, and there is not a monitoring device always available in the area where the fire occurs, which is easy to miss or delay the fire rescue.

(3) Another way is to distribute the satellite remote sensing thermal anomaly information, and combine the network and manual telephone notification to obtain the fire information, that is, the existing technical scheme is that the forest fire satellite monitoring system in National Forestry and Grassland Administration will send the fire information to the provincial fire prevention office through the network after manually confirming the thermal anomaly point, and then the duty officer of the provincial fire prevention office will notify the county-level fire prevention office staff in the county where the thermal anomaly is located by telephone, and the county-level fire prevention office will organize relevant personnel to verify the thermal anomaly.

(4) By building ground base stations in forest areas as relay stations of sensor networks, ground base stations are easily affected by terrain and fire spread, resulting in communication obstruction and destruction.

In the prior art, it is necessary for an aircraft-based field monitoring device that may be flexibly deployed and may timely and efficiently send back a variety of field data to facilitate rapid decision-making at emergency rescue moments involving public safety, such as disaster occurrence, disaster prevention, wildlife monitoring and fugitive monitoring.

### SUMMARY

In view of the above defects of the prior art, the present application provides a field disaster monitoring system based on an aircraft (such as a general aircraft) and a monitoring method thereof. The aircraft deploys the sensor communication equipment by airdrop, and relays the ground data, and transmits the on-site information monitored by the sensor to the monitoring center at a long distance, so that the monitoring center may monitor the on-site situation according to the real-time video, temperature, air pressure and other data of the target area, and make timely decisions.

In order to achieve the above objectives, the present application provides the following technical scheme.

A field disaster monitoring system based on an aircraft relay communication, including a sensing communication terminal, an aircraft relay station and a data center server;
the sensing communication terminal is airdropped to a ground through an aircraft for collecting various types of data information in a field area in real time, and the sensing communication terminal is connected with an airborne aircraft relay station through wireless signals for transmitting collected various types of data information to the aircraft relay station; the sensing communication terminal is also used for receiving control instructions output by the aircraft relay station;
the aircraft relay station is in communication connection with the data center server through a wireless network, and is used for sending the various types of the data information to the data center server and sending control instructions output by the data center server to the aircraft relay station; and
the data center server is used for receiving, storing or outputting the various types of the data information, performing an analysis and an intelligent decision-making according to the various types of the data information, and outputting the control instructions to the aircraft relay station according to results of the analysis and the intelligent decision-making.

As a preferred scheme of the present application, the sensing communication terminal includes a sensor, a data processing module and a terminal communication module;
the sensor is used for collecting the various types of the data information in the field area in real time;
an output end of the sensor is connected with the data processing module and used for sending the various types of the data information to the data processing module;
the data processing module packages the various types of the data information collected by the sensor into data blocks and sends the data blocks to the terminal communication module; and
the terminal communication module sends the data blocks to the aircraft relay station.

As a preferred scheme of the present application, the various types of the data information include, but are not limited to, environmental state data, video data and location information.

As a preferred scheme of the present application, the sensing communication terminal further includes a terminal frame;
a sensor module, the data processing module and the terminal communication module are installed on the terminal frame, and the terminal frame is used to provide protection and auxiliary functions for the sensor module, the data processing module and the terminal communication module, and the protection and auxiliary functions include, but not limited to, airdrop shakeproof, fire prevention, waterproof, power supply, lighting and orientation.

As a preferred scheme of the application, the terminal frame includes an airborne component, a counterweight component and a human-computer interaction component;
the airborne component enables the sensing communication terminal to be dropped by a parachute mechanism or a free fall way; the counterweight component is used for fixing the sensing communication terminal so that the sensing communication terminal is not moved by an external force; and the human-computer interaction component is used for performing a parameter configuration of the sensing communication terminal.

As a preferred scheme of the application, the terminal frame further includes a terminal pan-tilt, and the terminal pan-tilt is capable of realizing a rotation of 360° in a horizontal direction and a rotation of +90° to −90° in a vertical direction to monitor the various types of the data information at fixed points.

As a preferred scheme of the application, the sensors include but are not limited to image sensor, infrared sensor, sound sensor, air pressure sensor, humidity sensor, temperature sensor, wind direction sensor, smoke sensor, orientation sensor, height sensor, vibration sensor, displacement sensor, distance sensor, Beidou or GPS positioning sensor.

As a preferred scheme of the present application, the functions of the terminal communication module include, but are not limited to, a wireless communication between adjacent sensing communication terminals; a wireless communication between the sensor communication terminal and the aircraft relay station or a ground relay station; collecting and transmitting signals and data of the sensors; temporarily stopping a data transmission when a relay is not possible; resuming the data transmission when the relay is resumed; receiving the control instructions of the data center server.

As a preferred scheme of the present application, when the terminal communication module monitors communication signals of the aircraft relay station, the terminal communication module turns on an own communication function, and the sensing communication terminal transmits cached historical data to the aircraft relay station and uploads the various types of the data information at present; when the sensing communication terminal does not monitor the communication signals of the aircraft relay station, the sensing communication terminal turns off an own communication function and stores detected various types of the data information locally.

As a preferred scheme of the present application, the aircraft relay station includes an airborne wireless communication system, and the airborne wireless communication system mainly includes airborne wireless communication base stations, and provides radio access network by using different frequency bands.

As a preferred scheme of the present application, the data center server includes a wireless communication system, a disaster analysis system, an air traffic control command system and a material dispatching system;
the wireless communication system is used for establishing a two-way communication with the aircraft relay station;
the disaster analysis system is used for generating emergency rescue analysis results for making decisions according to the various types of the data information;
the air traffic control command system is used for carrying out an environmental modeling on a flight area of the aircraft according to the emergency rescue analysis results, constructing a navigation path planning model, solving a flight path according to a model, and issuing flight instructions to the aircraft to adjust a flight state in real time; and
the material dispatching system is used for establishing a navigation emergency dispatching mathematical model according to the emergency rescue analysis results and developing a dispatching scheme.

As a preferred scheme of the present application, the data center server further includes a terminal deployment system, and the terminal deployment system includes a terminal deployment planning system and a terminal deployment aircraft; and
the terminal deployment planning system is used for generating a deployment plan of the sensor communication terminal, and deployment contents include time, place and method of the sensor communication terminal dropped and types of the sensor communication terminal dropped.

Based on the same idea, a field disaster monitoring method based on an aircraft relay communication is also proposed, which includes the following steps:
S1, constructing a field disaster monitoring system based on the aircraft relay communication as claimed in any one of claims 1 to 10;
S2, sending collected various types of data information to an aircraft relay station through wireless signals by the sensing communication terminal;
S3, sending the various types of the data information to a data center server through a wireless network by the aircraft relay station; and
S4, receiving, storing or outputting the various types of the data information, and performing an analysis and an intelligent decision-making according to the various types of the data information by the data center server.

Compared with the prior art, the application has the following beneficial effects.

The application provides a field disaster monitoring system and method based on an aircraft relay communication. Based on the system, the aircraft deploys sensing and communication equipment by airdrop, relays ground data, and transmits the information monitored by sensors to a monitoring center, so that the monitoring center may monitor the field disaster situation according to the video, temperature, air pressure and other data of the target area obtained in real time. When preventing or monitoring field disasters, the system may quickly build a communication network and a data acquisition system, and return the field information so as to facilitate timely decision-making; the system has strong emergency response capability, low requirements on the ground environment, and requires no rely on any ground facilities or any ground personnel while offering real-time monitoring capability and strong flexibility.

### BRIEF DESCRIPTION OF THE DRAWINGS

FIG. 1 is a schematic block diagram of a field disaster monitoring system based on an aircraft relay communication in Embodiment 1 of the present application.

FIG. 2 is a flowchart of the field disaster monitoring based on the aircraft relay communication in Embodiment 1 of the present application.

FIG. 3 is a schematic block diagram of a sensing communication terminal in Embodiment 1 of the present application.

FIG. 4 is an implementation architecture of the sensing communication terminal in Embodiment 1 of the present application.

FIG. 5 is a flowchart of the caching function of the sensing communication terminal in Embodiment 1 of the present application.

FIG. 6 is a schematic block diagram of an aircraft relay station in Embodiment 1 of the present application.

FIG. 7 is an architecture diagram of the disaster prevention and control command center in Embodiment 1 of the present application.

FIG. 8 is an architecture diagram of a terminal deployment system in Embodiment 1 of the present application.

FIG. 9 is a specific deployment scenario of the field disaster monitoring system based on the aircraft relay communication in Embodiment 1 of the present application.

### DETAILED DESCRIPTION OF THE EMBODIMENTS

In the following, the application will be further described in detail in combination with experimental examples and specific embodiments. However, it should not be understood that the scope of the above-mentioned theme of the present application is limited to the following embodiments, and all technologies realized based on the contents of the present application belong to the first exemplary embodiment of the present application.

### Embodiment 1

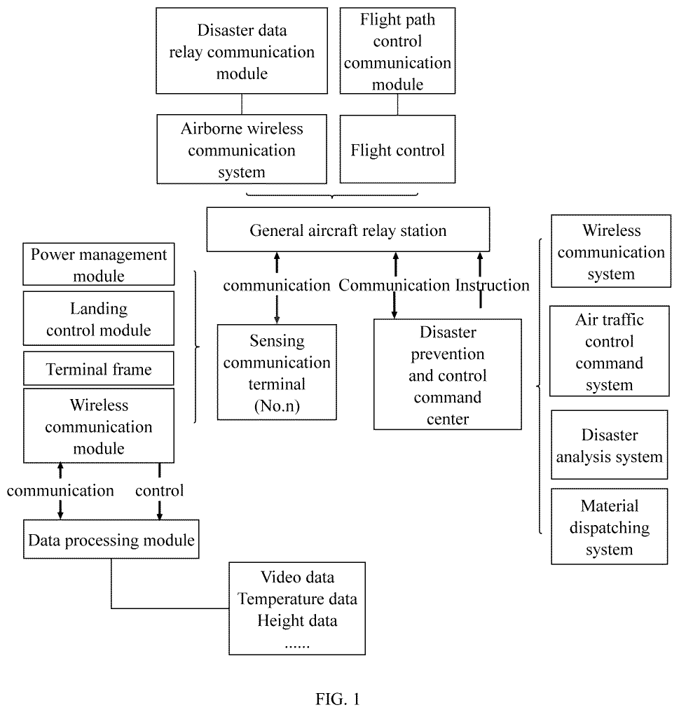

The application provides a field disaster monitoring system based on an aircraft relay communication, which may also be called a field disaster monitoring platform of relay communication, including a plurality of sensing communication terminals, aircraft relay stations and disaster prevention and control command centers, as shown in FIG. 1. In any field area to be detected, a plurality of sensing communication terminals are airdropped to the ground by the aircraft, and each sensing communication terminal is used to collect various types of data information of the field area to be monitored (the various types of data information refer to different information in different scenarios, and when encountering disasters, various types of data information are collected in real-time disaster environment information). The signal output end of each sensing communication terminal is connected with the relay base station of the airborne aircraft through wireless signals, and the relay base station of the aircraft is connected with the data center server of the disaster prevention and control command center through wireless networks. The data center server outputs the field information of the monitored area (in case of disaster, the information of the disaster spread state of the system is output).

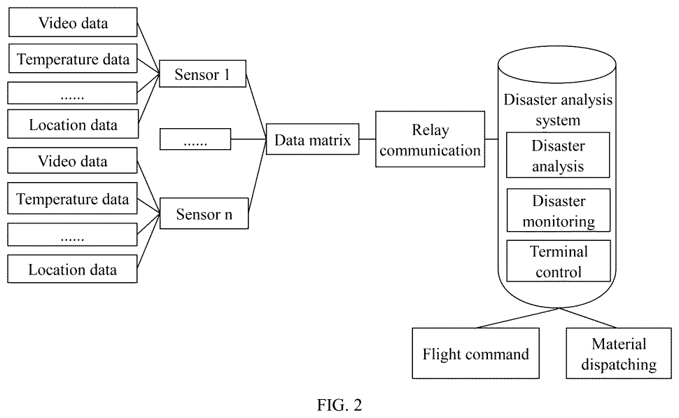

FIG. 2 is a flowchart of a field disaster monitoring method based on aircraft relay communication. In a certain field area, the sensing communication terminal is used to collect and monitor environmental information (such as temperature, humidity, smoke concentration, wind speed and direction, video, etc.) in the field area, and the sensing communication terminal is connected with the airborne aircraft through the wireless communication network, and the airborne aircraft is connected with the disaster prevention and control command center through the wireless communication network. The server of disaster prevention and control command center analyzes the collected data and conducts material dispatching and aircraft flight dispatching.

### Sensing Communication Terminal

The sensing communication terminal includes a plurality of sensors, a data processing module and a terminal communication module, where each sensor is used as an input end of field disaster monitoring data and is used for collecting environmental state information and video information of the area to be monitored. The signal output end of each sensor is connected with the data processing module, which is connected with the signal input end of the wireless communication module, and the output end of the wireless communication module is connected with the base station in the airborne aircraft through wireless signals, and terminals with different configurations may be used in coordination according to the needs of application scenarios.

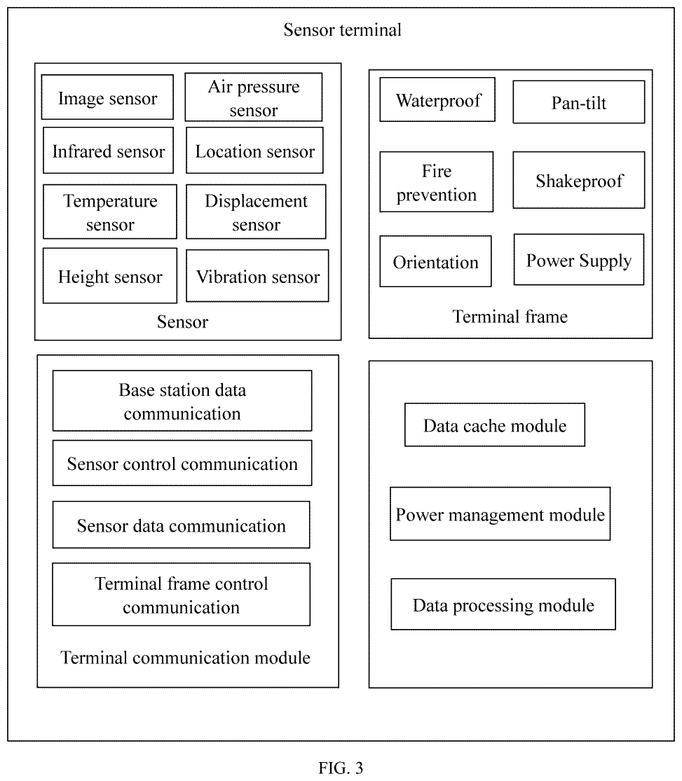

Further, as shown in FIG. 3, the sensor communication terminal consists of a sensor module, a data processing module, a terminal communication module, a power management module and a terminal frame.

The sensor module and the data processing module are interconnected, and the data processing module and the terminal communication module are interconnected, and the sensor module, the data processing module and the terminal communication module may be installed on the terminal frame as a whole. The terminal frame provides necessary protection and auxiliary functions for the sensor module, data processing module and terminal communication module. The protection and auxiliary functions include but are not limited to airdrop shakeproof, fire prevention, waterproof, power supply, lighting, orientation and other functions, and each function may be controlled by wireless signals. The terminal frame is also provided with a pan-tilt. For example, the camera sensor is installed on the rotatable terminal pan-tilt on the terminal frame, and the control signals of the pan-tilt are transmitted through the terminal communication module to realize remote control.

The terminal communication module controls the sensor according to the remote wireless control signal received by the aircraft relay station, and the terminal communication module and the sensor module may carry out two-way communication.

The sensor module of the sensing communication terminal includes but is not limited to the following sensors: image sensor, infrared sensor, sound sensor, air pressure sensor, humidity sensor, temperature sensor, wind direction sensor, smoke sensor, orientation sensor, height sensor, vibration sensor, displacement sensor, distance sensor, Beidou or GPS positioning sensor.

As a concrete embodiment, the sensor module include a binocular camera sensor, a humidity sensor, a temperature sensor, a wind speed and direction sensor, a smoke sensor and a GPS sensor. The working principle is as follows: after the sensor communication terminal is delivered to the ground, the sensor communication terminal starts the binocular camera sensor, temperature sensor, humidity sensor, smoke sensor, wind speed sensor and GPS sensor to collect data, and after collecting environmental state data, video data and location information, the data of each sensor is comprehensively processed and packaged in the data processing module and sent out through the terminal communication module.

The terminal pan-tilt is capable of realizing a rotation of 360° in a horizontal direction and a rotation of +90° to −90° in a vertical direction. On the real-time monitoring control interface of the disaster prevention and control command center, the staff may control the terminal pan-tilt to move according to certain rules through the communication relay network, and may purposefully monitor the environmental information (temperature, humidity, smoke concentration, wind speed and direction, video) in the field area.

The functions of the terminal communication module include but are not limited to: wireless communication between adjacent sensing communication terminals; wireless communication between sensor communication terminal and ground-based or space-based relay station; collecting and transmitting sensor signals and data; temporarily stopping a data transmission when a relay is not possible; resuming the data transmission when the relay is resumed; receiving the command signal from the disaster prevention and control command center to control the sensor and the terminal frame to perform corresponding actions (such as taking pictures by the image sensor or adjusting the direction of the terminal frame).

Because the aircraft does not hover over the forest area continuously, when the aircraft is far away from the sensor communication terminal, the sensor communication terminal may turn off the communication function and store the collected environmental data in a planned way. For example, in the routine forest patrol stage using general aircraft, the take-off times of aircraft are once a week or once every two weeks; when there is a fire in the wild, there will be different kinds of general aircraft continuously over the forest area. There is a huge difference in the time of the general aircraft relay in the air between the two situations, so the sensor communication terminal is designed so that when the general aircraft relay is far away from the sensor communication terminal, all the sensor communication terminals may turn off the communication function, reduce energy consumption, and store the collected environmental state data, video data and location information according to the predetermined time interval.

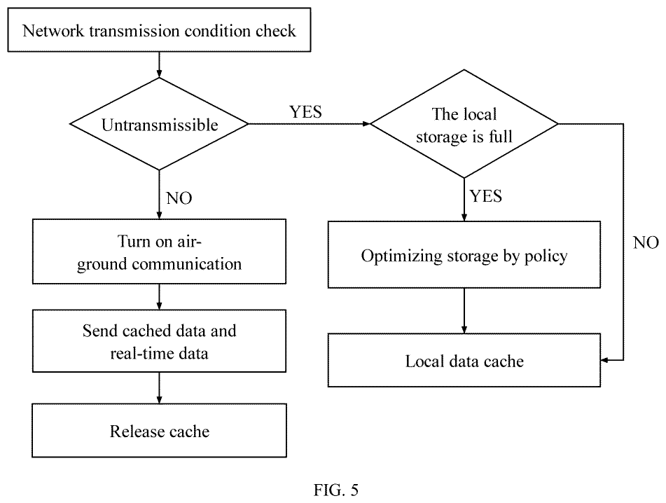

As shown in FIG. 5, when the sensing communication terminal monitors the relay signal of the aircraft, the sensing communication terminal turns on its own communication function, transmits the cached historical data to the aircraft relay station, uploads the current environmental state data, video data and location information in real time at the same time, and releases the cached data after uploading the cached data. When the sensing communication terminal does not monitor the relay signal of the aircraft, the communication function of the node is turned off, and the detected environmental state data, video data and location information are stored locally. When the storage is insufficient, the early data may be deleted according to different strategies, such as (1) deleting the early data; (2) compressing the data; (3) reducing the resolution of video or image sensing; (4) extending the time interval of data acquisition and other ways to increase storage space or reduce space consumption to ensure data backup.

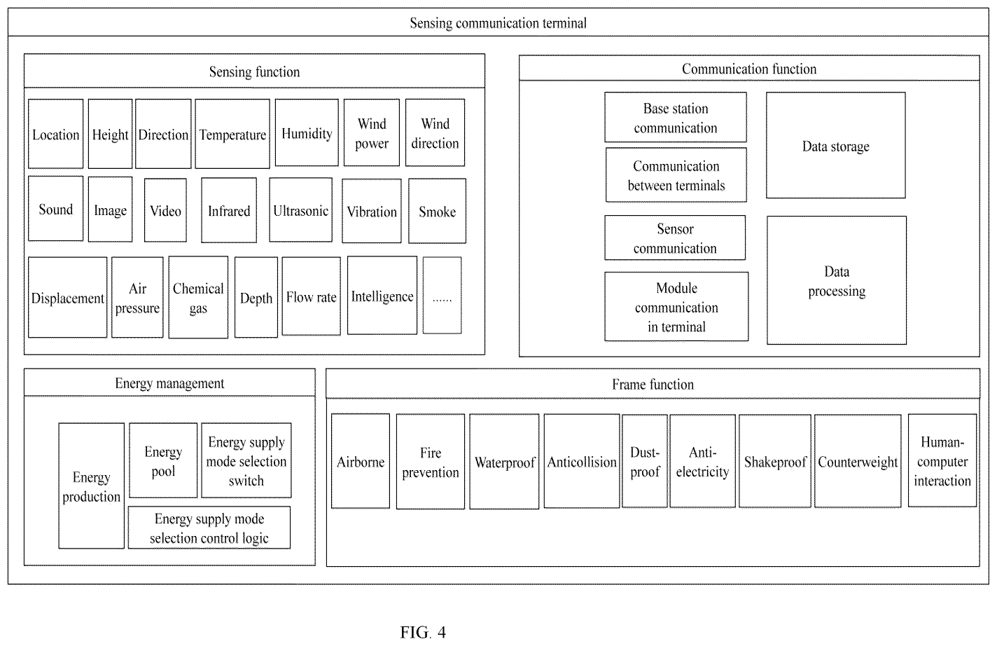

As a concrete embodiment, the implementation architecture of the sensing communication terminal is shown in FIG. 4, and the sensing communication terminal includes (not limited to) the following functional modules.

1. Sensing function module: providing various sensing capabilities according to the needs of data sensing in different field scenes (fire, flood, earthquake, lifesaving or manhunting, etc.); a, according to the requirements of different scenes, different types and specifications of sensors may be equipped; b, smart sensors may be equipped; c, it is not limited to the sensors listed in FIG. 4, nor to the scenarios listed in this embodiment; d, in the deployment of sensor communication terminals, different types of terminals with different sensors may be deployed.

2. Communication function module: communication, data storage and processing; a, information transmission and reception with air and ground relay stations; b, in the sensor network composed of terminals, information may be transmitted and received between terminals, and in some scenarios, information may be transmitted between terminals; c, receiving, sending, collecting and managing sensor data and control information inside the terminals; d, power management status and control information transmitting and receiving management; f, the state of the terminal frame and the transmitting and receiving management of control information.

3. Power management module: used for providing energy for the components of the terminal that need energy to drive, and storing or producing the energy; the energy supply of each component is controlled by switches, and each switch may be operated by manual, remote instructions or control logic of the terminal; a, under a certain strategy, energy switch logic may adopt the method of timing; b, solar energy may be used for energy production; c, under certain strategies, the energy supply switch may be controlled by remote control.

4. The terminal frame module provides a physical framework for each component, and protects each component to ensure the normal operation in various scenarios; a, airborne components: under a certain deployment strategy, the location requirements of terminal equipment are not high, and they may be released by simple parachute dropping mechanism or free fall; when the terminal needs precise positioning, the airborne component may be composed of a small UAV with GPS or Beidou positioning, or a platform with remote control; under the strategy of mobile deployment, the disaster prevention and control command center may remotely control the airborne components and deploy the already deployed terminal equipment to a new location; b, counterweight component: in the scene of strong wind or flood, the counterweight component may fix the terminal in a certain place without being moved by external force; c, human-computer interaction components, through which equipment may be manually configured (such as small weight, power switch, etc.).

### Aircraft Relay Station

The aircraft of the application is equipped with an airborne wireless communication base station, which forms an air-ground communication network with the sensing communication terminal and the disaster prevention and control command center dropped in the early stage, so that the sensing communication terminal and the disaster prevention and control command center have communication capability.

The airborne base station aircraft may be the same aircraft or multiple aircraft, which is completed by unmanned aerial vehicles, helicopters, fixed-wing aircraft, airships, balloons, etc., forming a communication link of one base station or forming a communication network of multiple base stations.

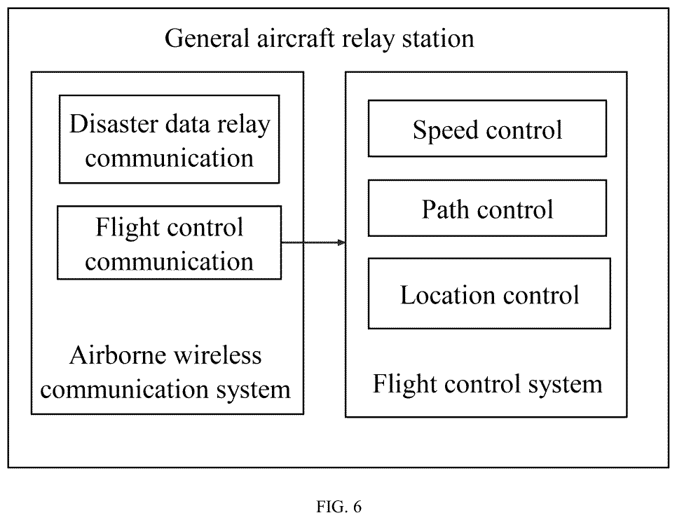

As shown in FIG. 6, the aircraft relay station of the present application is mounted on an aircraft. Aircraft relay stations include airborne wireless communication systems, which are mainly composed of airborne wireless communication base stations and provide radio access network using different frequency bands. The airborne wireless communication base station of aircraft relay station is mainly used for air-to-air and air-to-ground communication, and completes the function of transmitting and receiving radio frequency signals. The working process of the airborne wireless communication base station is as follows: the airborne wireless communication base station receives the data signals of the ground sensing communication terminal, sends the data signals to the airborne switch through the network port, and finally the base station antenna transmits the data signals to the disaster prevention and control command center. Conversely, the airborne wireless communication base station receives the control information of the disaster prevention and control command center, sends the control information to the airborne switch through the network port, and finally transmits the control information to the ground sensing communication terminal through the base station antenna.

The aircraft relay station also includes the flight control system, which mainly realizes the flight control of the aircraft through the flight path control communication module, where the flight path control communication module receives control instructions from the ground through the control communication equipment carried on the aircraft, and the flight operator or automatic flight equipment adjusts the flight height, position, speed and flight path according to the control instructions.

### Disaster Prevention and Control Command Center

The disaster prevention and control command center of the application receives the information of the sensing communication terminal through air-based or ground-based relay, and may also analyze data and visualize data through the received information, conduct video, voice calls, text or multimedia message and send instructions to the sensor communication terminal.

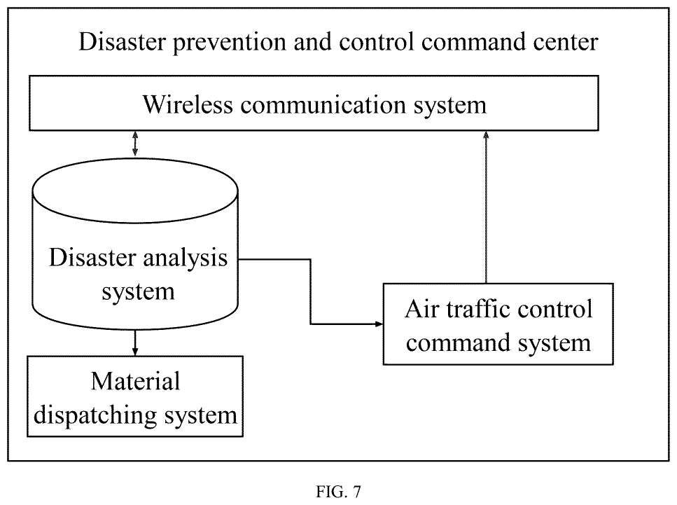

As shown in FIG. 7, the disaster prevention and control command center includes a central wireless communication system, a disaster analysis system, an air traffic control command system and a material dispatching system. The disaster prevention and control command center uses the central wireless communication system to communicate with the aircraft relay station in two directions. The disaster analysis system receives the data transmitted by the aircraft relay station for disaster analysis, visual display and remote control of the front-end equipment. The air traffic control command system is used to command the flight state of the aircraft according to the disaster analysis results. The material dispatching system forms a dispatching scheme according to the disaster analysis results and other information.

### 1. Disaster Analysis System

Taking fire disaster as an example, the disaster analysis system is mainly responsible for receiving and storing the data of wireless sensors and video monitoring nodes, providing a friendly and humanized interface for the staff of the monitoring and early warning center, the staff may intuitively see the situation of the fire scene through the interface, and send different instructions to the sensing communication terminal through the control interface for collecting the information of the wild forest environment or the real-time video information in the wild; the collected data is saved to the server-side database in real time, and the data is preprocessed or decisions are made according to the data. The spread information of the fire site is obtained through a plurality of sensor communication terminals, and the server-side website makes decisions on the field fire based on the data stored in the database in real time, and displays the real-time video information of the detailed data of the field environmental factors in the form of web pages.

### 2. Air Traffic Control Command System

The air traffic control command system analyzes the spread result of disasters by the disaster analysis system, and carries out environmental modeling on the flight area of the aircraft by using grid ideas and real terrain data aiming at the flight route of the aircraft; considering multiple factors, such as terrain obstacles, flight rules, aircraft performance, disaster spread state and so on, and at the same time requiring the cost to reach the optimal constraint conditions, a navigation path planning model is constructed, and the flight path is obtained according to the model solution, and relevant instructions are issued to the aircraft to adjust the flight state in real time.

### 3. Material Dispatching System

According to the spread result of the disaster analyzed by the disaster analysis system, the material dispatching system firstly takes the rescue efficiency and total flight mileage as the objective functions, and considers the influence factors such as the demand of the affected point, the rescue time limit, the number of aircraft and the load, etc., and establishes a “many-to-many” navigation emergency dispatching mathematical model. Then, the dispatching scheme is formed by using the built-in intelligent heuristic algorithms (improved ant colony algorithm, genetic algorithm, etc.).

### 4. Terminal Deployment System

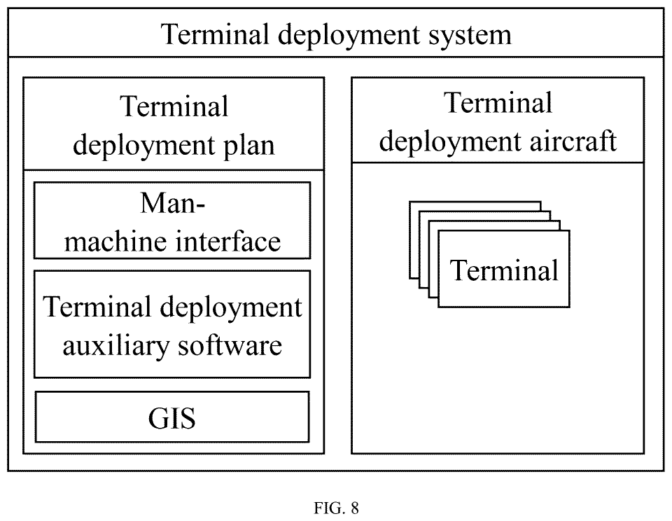

Further, the disaster monitoring may also input the field environment information and video data collected by the sensor communication terminal node into the terminal deployment system. The architecture diagram of the terminal deployment system is shown in FIG. 8, and the terminal deployment system consists of a terminal deployment planning system and a terminal deployment aircraft. The terminal deployment planning system is responsible for planning the terminal deployment, and determining when, where, in what way, what kind of terminal to deploy and other terminal deployment task plans; according to the planning of the terminal deployment planning system, the terminal deployment aircraft releases the sensing communication terminal. In the computer-aided planning scenario, the geographical data is obtained through GIS, and the planner may select the terminal equipment and launch site through the “terminal deployment auxiliary software”, and may carry out activities such as route planning, time planning, launch simulation and so on with the help of the auxiliary software to complete the plan. The terminal deployment aircraft loads the terminal equipment and releases the terminal device as planned. The terminal deployment system may also input the field environment information and video data into the deep learning network. If it is judged that there is a disaster, the location information will be sent back to the monitoring center through the Beidou positioning system of the wireless sensor, and the monitoring center will use the GIS geographic information system to adjust the relevant data of the sensor to understand and master the overall situation of the disaster and realize accurate positioning.

### Recovery and Utilization of Sensing Communication Terminal Equipment

The disaster prevention and control command center may recover the terminal equipment when necessary or after the disaster according to the location information sent back by the location of the sensing communication terminal. During the disaster, if the affected or disaster relief personnel find the equipment, the equipment may be used to establish communication with the monitoring center to obtain rescue or coordinate disaster relief operations.

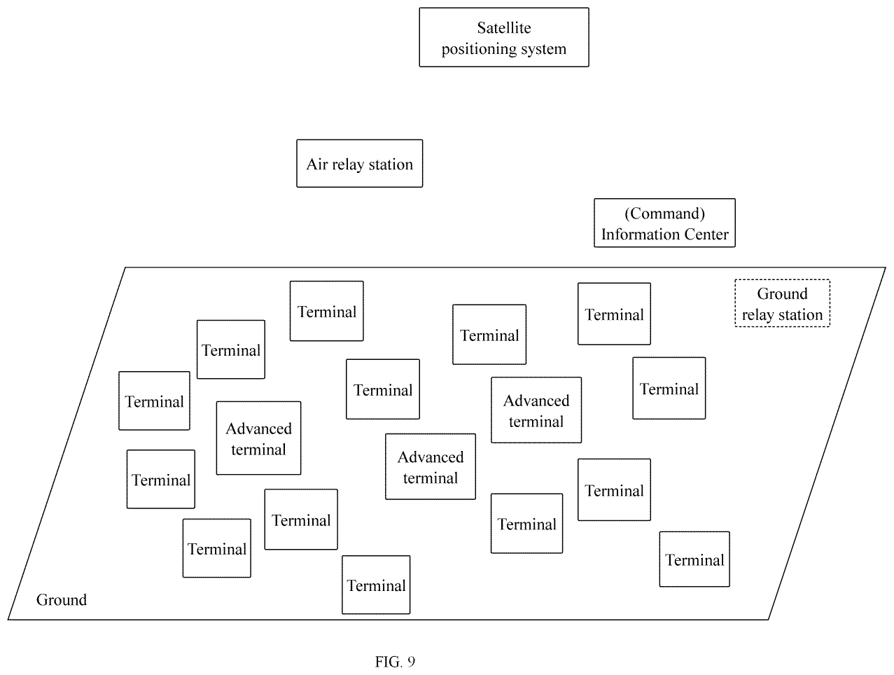

FIG. 9 shows a specific deployment scenario of a field disaster monitoring system based on aircraft relay communication. A plurality of different types of terminals are deployed to the ground according to the deployment plan to form a sensor network. Some of these terminals have the ability of short-range communication, and may transmit the sensing information to other more advanced terminals around them. Advanced terminals gather nearby terminal information and transmit it to air relay stations or ground relay stations (fixed relay stations or vehicle-mounted mobile relay stations). The air relay station or the ground relay station may transmit the on-site sensing information to the disaster prevention and control command center (there may be multiple centers, fixed, air-based or mobile), and the command information center will send the control information to the on-site terminal through the air relay station or the ground relay station for control. Satellite positioning systems such as Beidou or GPS provide positioning information for each device.

The application has the following beneficial effects.

The scheme is robust and has strong emergency capability, and has low requirements for the ground environment. Without relying on any ground facilities or any ground personnel, the monitoring ability may be established in real time.

Large amount of data: the deployment of multi-terminals and real-time data collection and communication of multi-sensors are helpful for the disaster prevention and control command center to comprehensively and meticulously understand and master the field disasters and obtain feedback quickly.

High degree of automation: no need for ground field personnel, avoiding human error and ensuring personnel safety.

Low cost: there is no need for permanent facilities and personnel in the field, the sensor communication terminal may be recycled and reused, and the difficulty of airdropping in a large area is low.

The base stations in the network adopt wireless communication, thus overcoming the shortcomings of traditional base station communication affected by terrain and disasters. The transmission speed and bandwidth are greatly improved, and the communication between the aircraft relay communication station and the ground sensing communication terminal and the remote data center server is more convenient.

Backup function of sensor communication terminal: the sensor communication terminal has added the backup function, and when receiving the signal from the airborne aircraft relay communication, the historical environment information and real-time information collected by the sensor communication terminal are uploaded. When there is no signal of aircraft relay communication, the air-ground communication transmission is closed and the collected environmental information is saved.

Good real-time monitoring: when a disaster occurs, the wireless sensor may receive environmental information and video information and transmit data to the monitoring room through the communication module and satellite communication model carried by the airborne aircraft relay station.

Data record the whole process of disaster occurrence, development and elimination, which may provide real and effective intuitive data for the prevention and treatment of future field disasters.

The basic principles, main features and advantages of the present application have been shown and described above, and it is obvious to those skilled in the art that the present application may be realized in other specific forms without departing from the spirit or basic features of the present application. Therefore, the embodiments should be considered in all aspects as illustrative and not restrictive, and the scope of the application is defined by the appended claims rather than the above description, so it is intended to embrace all changes that come within the meaning and range of equivalents of the claims. Any reference signs in the claims shall not be construed as limiting the claims concerned.

In addition, it should be understood that although this specification is described according to the implementation, the implementation does not only include an independent technical solution, and this description of the specification is only for the sake of clarity. The technical personnel in the field should take the specification as a whole, and the technical solutions in the embodiments may also be combined appropriately to form other embodiments that may be understood by the technical personnel in the field.

What is claimed is:

1. A field disaster monitoring system based on an aircraft relay communication, comprising a sensing communication terminal, an aircraft relay station and a data center server;
the sensing communication terminal is airdropped to a ground through an aircraft for collecting various types of data information in a field area in real time, and the sensing communication terminal is connected with an airborne aircraft relay station through wireless signals for transmitting collected various types of data information to the aircraft relay station; the sensing communication terminal is also used for receiving control instructions output by the aircraft relay station;
the aircraft relay station is in communication connection with the data center server through a wireless network, and is used for sending the various types of the data information to the data center server and sending control instructions output by the data center server to the aircraft relay station; and
the data center server is used for receiving, storing or outputting the various types of the data information, performing an analysis and an intelligent decision-making according to the various types of the data information, and outputting the control instructions to the aircraft relay station according to results of the analysis and the intelligent decision-making;
wherein the aircraft relay station comprises an airborne wireless communication system, and the airborne wireless communication system comprises an airborne wireless communication base station, and the airborne wireless communication base station uses different frequency bands to provide a radio access network;
the airborne wireless communication base station of the aircraft relay station is used for an air-to-air and air-to-ground communication to complete functions of transmitting and receiving radio frequency signals,
a working process of the airborne wireless communication base station is as follows: the airborne wireless communication base station receives data signals of a ground sensing communication terminal and sends the data signals to an airborne switch through a network port, and finally a base station antenna transmits the data signals to a disaster prevention and control command center; the airborne wireless communication base station receives control information of the disaster prevention and control command center, sends the control information to the airborne switch through the network port, and finally the base station antenna transmits the control information to the ground sensing communication terminal;
the data center server comprises a wireless communication system, a disaster analysis system, an air traffic control command system and a material dispatching system;
the wireless communication system is used for establishing a two-way communication with the aircraft relay station;
the disaster analysis system is used for generating emergency rescue analysis results for making decisions according to the various types of the data information;
the air traffic control command system is used for carrying out an environmental modeling on a flight area of the aircraft according to the emergency rescue analysis results, constructing a navigation path planning model, solving a flight path according to a model, and issuing flight instructions to the aircraft to adjust a flight state in real time; the environmental modeling is to perform the environmental modeling of the flight area of the aircraft according to a grid idea and real terrain data; and
the material dispatching system is used for establishing a navigation emergency dispatching mathematical model according to the emergency rescue analysis results and forming a dispatching scheme; a working process of the material dispatching system comprises: firstly, taking a rescue efficiency and a total flight mileage as objective functions, considering influence factors of disaster point demands, a rescue time limit, a aircraft number and a load, establishing the navigation emergency dispatching mathematical model; then, the dispatching scheme is formed by using a built-in intelligent heuristic algorithm, and the built-in intelligent heuristic algorithm comprises an improved ant colony algorithm or a genetic algorithm.

2. The field disaster monitoring system based on the aircraft relay communication according to claim 1, wherein the sensing communication terminal comprises a sensor, a data processing module and a terminal communication module,
the sensor is used for collecting the various types of the data information in the field area in real time;
an output end of the sensor is connected with the data processing module and used for sending the various types of the data information to the data processing module;
the data processing module packages the various types of the data information collected by the sensor into data blocks and sends the data blocks to the terminal communication module; and
the terminal communication module sends the data blocks to the aircraft relay station.

3. The field disaster monitoring system based on the aircraft relay communication according to claim 2, wherein the various types of the data information comprise environmental state data, video data and location information.

4. The field disaster monitoring system based on the aircraft relay communication according to claim 3, wherein the sensing communication terminal further comprises a terminal frame, a sensor module, the data processing module and the terminal communication module are installed on the terminal frame, and the terminal frame is used to provide protection and auxiliary functions for the sensor module, the data processing module and the terminal communication module, and the protection and auxiliary functions comprise airdrop shakeproof, fire prevention, waterproof, power supply, lighting and orientation.

5. The field disaster monitoring system based on the aircraft relay communication according to claim 4, wherein the terminal frame comprises an airborne component, a counterweight component and a human-computer interaction component,
the airborne component enables the sensing communication terminal to be dropped by a parachute mechanism or a free fall way; the counterweight component is used for fixing the sensing communication terminal so that the sensing communication terminal is not moved by an external force; the human-computer interaction component is used for performing a parameter configuration of the sensing communication terminal.

6. The field disaster monitoring system based on the aircraft relay communication as claimed in claim 5, wherein the terminal frame further comprises a terminal pan-tilt, and the terminal pan-tilt is capable of realizing a rotation of 360° in a horizontal direction and a rotation of +90° to −90° in a vertical direction to monitor the various types of the data information at fixed points.

7. The field disaster monitoring system based on the aircraft relay communication according to claim 2, wherein the sensors comprise an image sensor, an infrared sensor, a sound sensor, an air pressure sensor, a humidity sensor, a temperature sensor, a wind direction sensor, a smoke sensor, an orientation sensor, a height sensor, a vibration sensor, a displacement sensor, a distance sensor, a Beidou or GPS positioning sensor.

8. The field disaster monitoring system based on the aircraft relay communication according to claim 2, wherein functions of the terminal communication module comprise: a wireless communication between adjacent sensing communication terminals; a wireless communication between the sensor communication terminal and the aircraft relay station or a ground relay station; collecting and transmit signals and data of the sensors; temporarily stopping a data transmission when a relay is not possible; resuming the data transmission when the relay is resumed; receiving the control instructions of the data center server.

9. The field disaster monitoring system based on the aircraft relay communication according to claim 8, wherein when the terminal communication module monitors communication signals of the aircraft relay station, the terminal communication module turns on an own communication function, and the sensing communication terminal transmits cached historical data to the aircraft relay station and uploads the various types of the data information at present; when the sensing communication terminal does not monitor the communication signals of the aircraft relay station, the sensing communication terminal turns off an own communication function and stores detected various types of the data information locally.

10. The field disaster monitoring system based on the aircraft relay communication according to claim 1, wherein the data center server further comprises a terminal deployment system, and the terminal deployment system comprises a terminal deployment planning system and a terminal deployment aircraft;
wherein the terminal deployment planning system is used for generating a deployment plan of the sensor communication terminal, and deployment contents comprise a time, a place and a method dropped by the sensor communication terminal and types dropped by the sensor communication terminal.

11. A field disaster monitoring method based on an aircraft relay communication, comprising following steps:
S1, constructing a field disaster monitoring system based on the aircraft relay communication as claimed in claim 1;
S2, sending collected various types of data information to an aircraft relay station through wireless signals by the sensing communication terminal;
S3, sending the various types of the data information to a data center server through a wireless network by the aircraft relay station; and
S4, receiving, storing or outputting the various types of the data information, and performing an analysis and an intelligent decision-making according to the various types of the data information by the data center server.
